(19) United States
(12) Patent Application Publication
(10) Pub. No.: US 2026/0210289 A1
(43) Pub. Date: Jul. 23, 2026

(54) AIRCRAFT TURBINE ENGINE COMPRISING A HEAT EXCHANGE SYSTEM

(71) Applicant: SAFRAN, Paris (FR)

(72) Inventors: Samer MAALOUF, Moissy-Cramayel (FR); Ephraim TOUBIANA, Moissy-Cramayel (FR)

(21) Appl. No.: 19/157,123

(22) PCT Filed: Feb. 16, 2024
(86) PCT No.: PCT/FR2024/050208

§ 371 Date: Aug. 15, 2025

(30) Foreign Application Priority Data
Feb. 23, 2023 (FR) FR2301668

(51) Int. Cl. F02C 7/14; F01D 25/12

(52) U.S. Cl. CPC F02C 7/14; F01D 25/125; F05D 2220/323; F05D 2260/213; F05D 2260/232

(57) ABSTRACT

An aircraft turbine engine having a longitudinal axis and including a primary oil circuit for cooling a mechanical device; a secondary oil circuit for cooling an electronic device, and a heat exchange system located in a duct to be swept by a gas flow, this heat exchange system including a first cooling circuit connected to the secondary oil circuit and a second cooling circuit connected to the primary oil circuit.

### FIELD OF THE INVENTION

The present invention relates to the general field of cooling, and its application in particular in the field of aeronautics. In particular, it is aimed at an aircraft turbine engine comprising a heat exchange system.

### TECHNICAL BACKGROUND

The technical background includes the documents US-A1-2013/086909, FR-A1-3,114,352, U.S. Pat. No. 4,696,1456, US-B2-7,908,840 and US-A1-2020/332718.

A turbine engine, in particular for an aircraft, comprises various members and/or items of equipment that need to be lubricated and/or cooled, such as rolling bearings and gears. The heat released by these components, which can be very high depending on the power of the member and/or the item of equipment, is transported by a fluid and evacuated towards cold sources available in the aircraft.

It is known to equip the turbine engine with one or more heat exchange systems to carry out the heat exchange between the fluid (typically oil) and the cold source (air, fuel, etc.). There are even different types of heat exchange systems, such as for example the fuel/oil heat exchangers, generally known by the acronym FCOC (Fuel Cooled Oil Cooler) and the air/oil heat exchangers, known by the acronym ACOC (Air-Cooled Oil Cooler).

The FCOC heat exchangers have a dual function of heating the fuel before the combustion in the combustion chamber of the turbine engine and cooling the oil heated by the thermal dissipations of the turbine engine. However, the heat exchangers FCOC are not sufficient to absorb all the thermal dissipations because the temperature of the fuel is limited for safety reasons.

The additional cooling is obtained by the heat exchangers ACOC, in particular those of the surface type referred by the acronym SACOC. The surface heat exchangers are usually arranged in the secondary duct of the turbine engine and use the secondary air flow to cool the oil circulating in the turbine engine. These heat exchangers are in the form of a metallic surface part allowing the passage of oil in machined channels. The secondary air flow is guided along a heat exchange matrix carried by this surface part, whose role is to increase the contact surface with the secondary air flow and extract heat. However, the disadvantage of the SACOC heat exchangers is that they create additional pressure losses in the relevant secondary duct, since they disturb the air flow, which has an impact on the performance of the turbine engine as well as on the specific fuel consumption.

The Applicant has already proposed a solution to this problem in the documents FR-A1-3 096 409 and FR-A1-3 096 444.

In addition, the cooling requirements of the lubricating fluid are increasing due to the higher rotational speeds and the power requirements to meet the specification trends on the turbine engines.

In fact, the ACOC heat exchangers are increasingly being used in the next generation of the engines due to the significant increase in heat dissipation, mainly due to:
the engines of the future will be larger, increasing the need for lubrication and oil cooling,
the presence of a speed reduction gear in new engine architectures, since this reduction gear transmits very high mechanical power and needs to be lubricated and cooled with oil, and
the addition of electric machines on board an engine for hybridization, these machines needing to be lubricated and cooled with oil.

The engine may comprise several oil circuits, each with a specific function, for example a first circuit for cooling the oil dedicated to the lubrication and cooling of the engine, a second for the lubrication and cooling of the engine reduction gear, a third for the cooling of the machines, etc. The temperature and oil flow rate must be controlled according to the corresponding circuit. For example, the oil used to lubricate and cool the electrical machines has a different temperature range to that used for engine cooling. Thus, the ACOC is preferably divided into several exchangers, each exchanger being dedicated to a given oil circuit. These different heat exchangers are generally distributed around the longitudinal axis of the engine.

The growing need for cooling has a direct impact on the dimensions of ACOCs. One must therefore expect to have large exchangers to be able to evacuate the calories from the oil. In order to evacuate the oil calories, the ACOCs could occupy all the available space in a duct, and thus extend all around the duct and over the entire height or radial dimension of the duct, in order to have the necessary air flow rate to evacuate the calories at the dimensioning point, which generally occurs during the take-off phase in the case of an extreme hot day.

However, the fact that the ACOC exchangers occupy the entire radial height of the duct prevents control of the flow through the exchanger using the solution described in the documents FR-A1-3 096 409 and FR-A1-3 096 444.

As a result, all the airflow passes through the ACOCs and each of the ACOCs operates with sub-optimal aerothermal performance. This results in a high pressure drop on the air side, leading to inefficient heat exchangers.

The aim of the present invention is to propose an improvement to existing technologies that optimises the efficiency of heat exchange while avoiding pressure losses and disturbing the gas flux as little as possible.

### SUMMARY OF THE INVENTION

The invention thus proposes an aircraft turbine engine, the turbine engine having a longitudinal axis and comprising:
a gas generator extending along the axis and comprising at least one compressor, an annular combustion chamber and at least one turbine,
a main oil circuit for cooling mechanical equipment of the turbine engine or gas generator,
a secondary oil circuit for cooling electronic equipment of the turbine engine or gas generator,
a flow duct for a gas flow, which flows in the turbine engine and/or gas generator, this duct being defined by two annular walls, respectively external and internal, which extend around each other and around the axis, and
a heat exchange system located in said duct to be swept by at least part of said gas flow, this heat exchange system comprising a first cooling circuit connected to the secondary oil circuit and a second cooling circuit connected to the main oil circuit,
characterized in that the heat exchange system comprises first and second annular heat exchange devices, which are independent and arranged axially one behind the other in the duct, the first heat exchange device comprising said first cooling circuit which is dedicated to cooling the secondary oil circuit, and the second heat exchange device comprising said second cooling circuit which is dedicated to cooling the main oil circuit, the first heat exchange device being located upstream of the second heat exchange device with respect to the direction of flow of the gas flow in the duct.

The present invention thus proposes to combine at least two annular heat exchange devices in the same annular duct for a gas flow. These devices are advantageously arranged in series, one behind the other, or one behind the other, which allows the aerodynamic impact of these devices in the duct to be minimized. These devices do not necessarily occupy the entire height of the duct and their arrangement with respect to each other, or with respect to each other, is advantageously chosen to optimise heat exchange efficiency. In particular, the exchange device dedicated to cooling the electronic equipment is arranged upstream of the exchange device dedicated to cooling the mechanical equipment. As the thermal power dissipated by the electronic equipment is lower than that dissipated by the mechanical equipment, the impact of heat exchange in the first device has little impact on the temperature of the gas flow passing through the second device, which can therefore in turn ensure optimum heat exchange.

The turbine engine according to the invention may comprise one or more of the following characteristics, considered independently of each other or in combination with each other:
the devices are carried by one of the walls and extend over only part of the height of the duct, this height being measured in a radial direction in an area of the duct in which the devices are located;
the devices extend over no more than 75%, or even at most 50%, of the height of the duct;
the devices each comprise a heat exchange matrix and a single annular cowl which is located between the walls of the duct and which covers the heat exchange matrices of the two devices, the cowl comprising a first end which is located upstream of the heat exchange matrix of the first device and which has a divergent shape with respect to the gas flow, and a second end which is located downstream of the heat exchange matrix of the second device and which as a shape that converges with respect to the gas flow;
the devices are connected to the two walls and extend over an entire height of the duct, this height being measured in a radial direction in an area of the duct in which the devices are located;
the heat exchange system comprises a third annular heat exchange device, which is independent of the first and second heat exchange devices and is arranged downstream of the first and second heat exchange devices, the third heat exchange device comprising a third cooling circuit;
the third device is carried by one of the walls and extends over only part of a height of the duct, this height being measured in a radial direction in an area of the duct in which the third device is located;
the first device is connected to the two walls and extends over a entire height of the duct, this height being measured in a radial direction in an area of the duct in which the first device is located,
the second device is carried by one of the walls and extends over only part of a height of the duct, this height being measured in a radial direction in an area of the duct in which the second device is located, and
the third device is carried by the other of the walls and extends over only part of a height of the duct, this height being measured in a radial direction in an area of the duct in which the third device is located;
each of the second and third devices comprises a heat exchange matrix and an annular cowl which is located between the walls of the duct and which covers this heat exchange matrix, the cowl comprising a first end which is located upstream of the heat exchange matrix and which has a divergent shape with respect to the gas flow, and a second end which is located downstream of the heat exchange matrix and which has a convergent shape with respect to this gas flow;
the cowls of the second and third devices are at an axial distance from each other, or overlap each other in the radial direction;
the mechanical equipment is a rolling bearing or a reduction gear, and the electronic equipment is a computer or an electrical machine;
the third cooling circuit is connected to a tertiary oil circuit for cooling other mechanical equipment;
the devices are at an axial distance from each other, or from one another;
   the first heat exchange device is of the surface type, and/or the second heat exchange device is of the surface type, and/or the third heat exchange device is of the surface type;
   said or each heat exchange device is of the SACOC or ACOC type;

The present invention also relates to a method of cooling at least one piece of mechanical equipment and one piece of electronic equipment in a turbine engine as described above, in which the secondary oil circuit comprises an oil having a temperature less than or equal to 90° C., and the main oil circuit, or even the tertiary oil circuit, comprises an oil having a temperature less than or equal to 160° C.

### BRIEF DESCRIPTION OF THE FIGURES

The invention will be better understood, and other purposes, details, characteristics and advantages thereof will become clearer upon reading the following detailed explanatory description of embodiments of the invention given as purely illustrative and non-limiting examples, with reference to the appended schematic drawings in which:

FIG. 1 is a schematic half-view in axial section of an example of a turbine engine to which the invention applies;

FIG. 2 is a schematic cross-sectional view of a heat exchange system;

FIG. 3 shows a very schematic axial section of the system shown in FIG. 2;

FIG. 4 is another very schematic view of a system similar to FIG. 3;

FIG. 5 is a partial schematic perspective view of a heat exchange device;

FIGS. 6a and 6b are highly schematic cross-sectional views of heat exchange systems each comprising a sectorized heat exchange device;

FIG. 7 is a very schematic axial cross-sectional view of the system in FIG. 6a;

FIG. 8 is a very schematic view in axial section of a turbine engine comprising a heat exchange system, according to a first embodiment of the invention;

FIG. 9 is a very schematic axial cross-sectional view of a turbine engine comprising a heat exchange system, according to a second embodiment of the invention; and

FIG. 10 is a very schematic view in axial section of a turbine engine comprising a heat exchange system, according to a third embodiment of the invention.

### DETAILED DESCRIPTION OF THE INVENTION

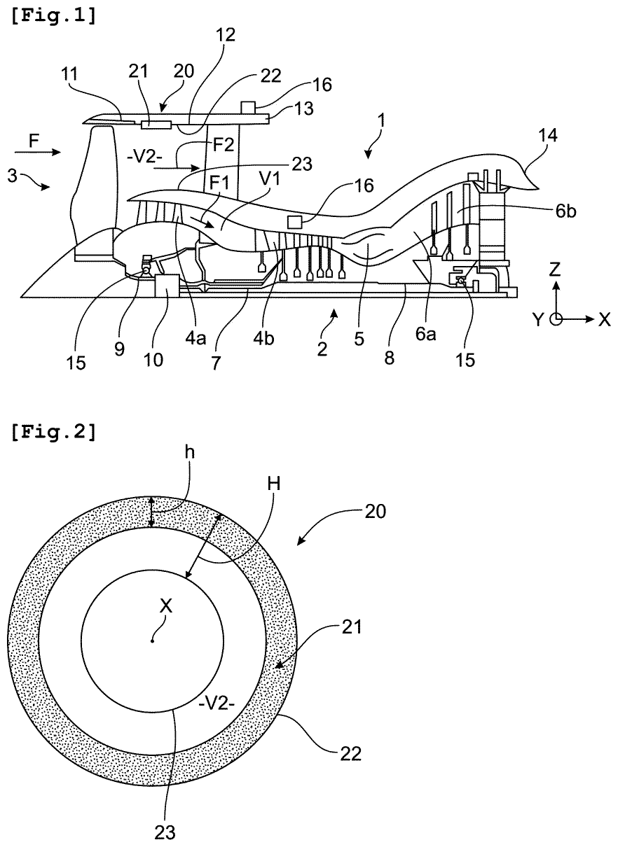

FIG. 1 shows an axial cross-sectional view of a turbine engine of longitudinal axis X to which the invention applies. The turbine engine shown is a double-flow turbine engine 1 intended to be mounted on an aircraft. Of course, the invention is not limited to this type of turbine engine.

This double-flow turbine engine 1 generally comprises a gas generator 2 upstream of which is mounted a fan or fan module 3.

In the present invention, the terms “upstream” and “downstream” are defined in relation to the flow of gases in the turbine engine 1 and here along the longitudinal axis X.

The gas generator 2 comprises a gas compressor assembly (here comprising a low-pressure compressor 4a and a high-pressure compressor 4b), an annular combustion chamber 5 and a turbine assembly (here comprising a high-pressure turbine 6a and a low-pressure turbine 6b).

Typically, the turbine engine 1 comprises a low-pressure shaft 7 which connects the low-pressure compressor 4a and the low-pressure turbine 6a to form a low-pressure casing, and a high-pressure shaft 8 which connects the high-pressure compressor 4b and the high-pressure turbine 6b to form a high-pressure body.

The low-pressure shaft 7, centered on the longitudinal axis X, drives a fan shaft 9 via a speed reduction gear 10. Rotational guide bearings 15 also allow the low-pressure shaft 7 to be guided in rotation relative to a fixed structure or stator of the turbine engine. The high-pressure shaft 8 is also guided in rotation by guide bearings (not shown).

The fan 3 is ducted in a fan casing 11 carried by a nacelle 12 and generates a primary air flow F1 which circulates through the gas generator 2 in a primary duct V1, and a secondary air flow F2 which circulates in a secondary duct V2 around the gas generator 2.

The secondary air flow F2 is ejected by a secondary nozzle 13 terminating the nacelle, while the primary air flow F1 is ejected outside the turbine engine 1 via an ejection nozzle 14 located downstream of the gas generator 2.

In the following description, the fan casing 11 and the nacelle 12 are considered as one single piece.

The guide bearings 15 and the speed reduction gear 10 in this example configuration of the turbine engine 1 must be lubricated and/or cooled to ensure the performance of the turbine engine 1. The power generated by these is dissipated in a fluid from a fluid supply source installed in the turbine engine 1, which is used to lubricate and/or cool various members and/or equipment of the turbine engine 1. Of course, other equipment of the turbine engine 1 generates heat that needs to be extracted from its environment. This is particularly the case for electronic equipment 16 on the turbine engine 1, such as computers for example.

To this end, the turbine engine 1 comprises a heat exchange system 20 that allows the fluid configured to lubricate and/or cool these members and/or items of equipment to be cooled. In this example, the fluid is an oil and the cold source for cooling the oil is a gas flow circulating in the turbine engine, in particular the secondary air flow F2.

A heat exchange system 20 comprises at least one annular heat exchange device which is located in a duct, this duct comprising two annular walls, external and internal respectively, which extend around each other and around the same axis X.

In FIG. 1, for example, the heat exchange system 20 of the turbine engine 1 comprises an external wall 22 formed by the fan casing 11 and/or the nacelle 12, an internal wall 23 formed by a casing of the gas generator 2, and a heat exchange device 21 which is carried by the external wall 22 and located in the duct V2.

The heat exchange device 21 is for example of the surface type (for example of the SACOC type) and preferably of the air/oil type.

The device 21 comprises an oil circuit and a heat exchange matrix located in duct V2 and configured to be swept by said gas flow F2. As mentioned above, the heat exchange matrix may comprise fins and/or plates and/or tubes. A matrix may be layered and comprise, for example, a stack of several layers, each of the layers comprising fins, or at least one plate or at least one tube. The fins are designed to be swept by a gas flow, and the plates or tubes are traversed by an oil circuit, for example, or comprise such an oil circuit.

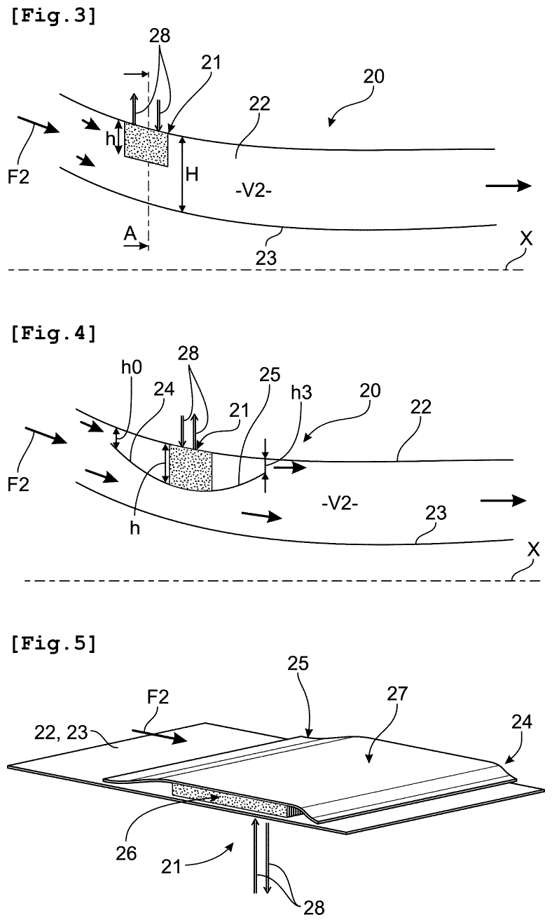

FIGS. 2 and 3 schematically show a heat exchange system 20 of this type. It can be seen that the heat exchange device 21 of this system 20 is annular and extends continuously over 360° around the axis X.

We can also see that it occupies only part of the height H of the duct V2. The device 21 has a height h or radial dimension which represents only part of the height H or radial dimension of the duct V2. These heights H, h are measured in a radial direction with respect to the axis X, in an area of the duct V2 in which this device 21 is located. The height H of the duct V2 is likely to change along the axis X.

One of the problems observed in a device 21 of this type is the disturbances and pressure drops generated in the gas flow F2, which has the effect of increasing the specific fuel consumption of the turbine engine 1. Hence the importance of optimising the aerothermal performance of this system 20.

In the aforementioned documents, the Applicant proposed a solution for optimising the integration of this type of device 21 in a duct, which is illustrated in FIG. 4. The idea is to slow down the speed of the gas flow through the device 21. The gas flow through the device 21 is highly turbulent. Slowing down the speed of flow of the air flow entering the device 21 allows its aerothermal performance to be optimized, thereby minimizing the pressure drop for a given heat dissipation. The control of the flow through the device 21 can be achieved by combining the device 21 with a divergent 24 at the inlet and a convergent 25. The divergent section 24 upstream of the device 21 is configured to compress and slow down the gas flow entering the device 21, and the convergent section 25 downstream of the device 21 is configured to accelerate and expand the gas flow leaving the device. At the inlet to device 21, the deceleration factor is inversely proportional to the ratio of the heights h/h0, h being the aforementioned height and h0 being the height at the inlet to the divergent 24. Note that the slower the flow, the lower the pressure drop generated by the device 21. At the outlet of the device 21, the acceleration factor is inversely proportional to the ratio of heights h/h3, h3 being the height at the outlet of the convergent 25.

FIG. 5 shows a perspective view of part of a heat exchange device 21. This shows the heat exchange matrix 26, which is sandwiched between a cowl 27 and the wall 22, 23 carrying the device 21. The convergent 25 and the divergent 24 can be formed by ends of the cowl 26, as in the example shown.

In FIG. 5 and the other figures, arrows are used to schematically represent the oil circuit 28.

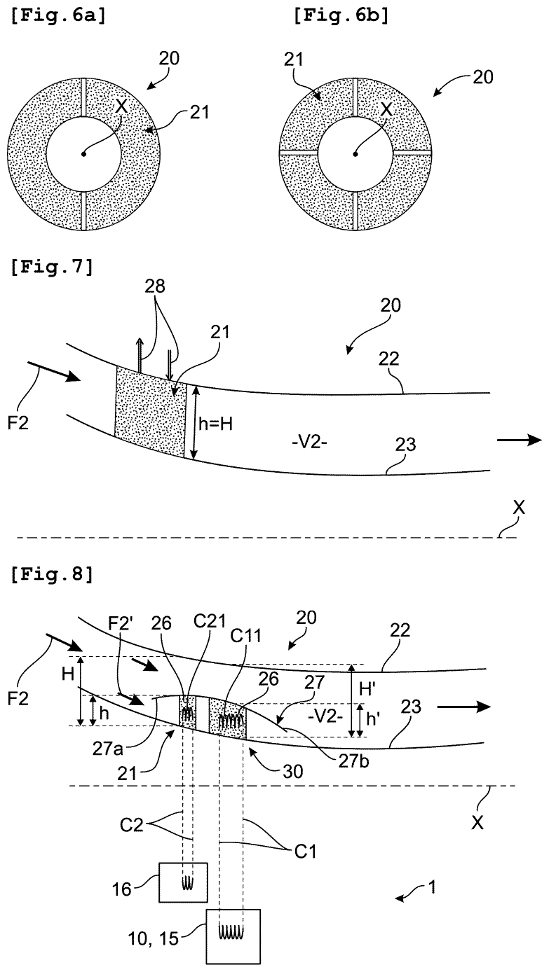

FIGS. 6a and 6b schematically show alternative versions of heat exchange systems 20.

In the case of FIG. 6a, the system 20 comprises an annular heat exchange device 21 which is sectorized and comprises two sectors each having an angular extent of approximately 180°.

In the case of FIG. 6b, the system 20 comprises an annular heat exchange device 21 which is sectorized and comprises four sectors each having an angular extent of approximately 90°.

In FIGS. 6a-6b, the heat exchange device 21 extends over the entire height H of the duct and is connected to the two walls 22, 23. The height h of the device 21 is then equal to the height H of the duct (FIG. 7).

The present invention is an improvement on this technology and offers a number of embodiments, which are illustrated in FIG. 8 and following.

One of the unique aspects of the invention is that the heat exchange system comprises at least two independent annular heat exchange devices, each of which is dedicated to cooling a different piece of equipment.

The turbine engine 1, which is very schematically represented by a rectangle in FIG. 8 and which may be comparable to that in FIG. 1, comprises:
a main oil circuit C1 for cooling mechanical equipment of the turbine engine 1 or gas generator 2, this mechanical equipment being, for example, a reduction gear 10 or a bearing 15, and
a secondary oil circuit C2 for cooling electronic equipment 16 of the turbine engine 1 or gas generator 2.

The heat exchange system 20 of the turbine engine 1 is located in a duct V2 of the type mentioned above and is swept by at least part of the gas flow F2 flowing in this duct. This heat exchange system 20 comprises a first cooling circuit C21 connected to the secondary oil circuit C2 and a second cooling circuit C11 connected to the main oil circuit C1.

According to the invention, the heat exchange system 20 comprises first and second annular heat exchange devices 21, 30, which are independent and arranged axially one behind the other in the duct V2.

The first heat exchange device 21 comprises the first cooling circuit C21 and is dedicated to cooling the secondary oil circuit C2 and therefore the electronic equipment 16.

The second heat exchange device 30 comprises the second cooling circuit C11 and is dedicated to cooling the main oil circuit C1 and therefore the mechanical equipment.

The first heat exchange device 21 is located upstream of the second heat exchange device 30 with respect to the direction of flow of the gas flow F2 in the duct V2.

In the example shown, the devices 21, 30 are located on the internal wall 23, but alternatively they could be located on the external wall 22.

These devices 21, 30 are preferably of the air-oil type and, for example, have a surface area, and each comprises a heat exchange matrix 26 located in the duct V2 and capped by an annular cowl 27.

In the example shown, the two devices 21, 30 have the same cowl 27 or share the same cowl 27.

The heat exchange matrices 26 of the devices 21, 30 are at an axial distance from each other and the cowl 27 comprises a first end 27a located upstream of the heat exchange matrix 26 of the device 21 with respect to the flow of the gas flow F2, and which has a divergent shape with respect to this gas flow F2, and a second end 27b located downstream of the heat exchange matrix 26 of the device 30 with respect to the flow of the gas flow F2, and which has a convergent shape with respect to this gas flow F2.

In the example shown, the ends 27a, 27b each have a truncated or domed shape.

Each of the devices 21, 30 may comprise a single heat exchange matrix 26, or may be sectorized and comprise two or more heat exchange matrices distributed around the axis X, as mentioned above.

In the example shown, the first device 21 on the left of the drawing is an upstream device occupying a height h in the duct of between 20 and 50% of the height H. The second device 30, on the right of the drawing, is a downstream device which occupies a height h′ in the duct of between 20 and 50% of the height H′. h′ may be greater or less than h.

It is understood that an internal peripheral part F2′ of the air flow F2 (for example 5 to 30% of the flow rate) flowing in the duct V2 will penetrate the device 21 while the rest will bypass the device 21 from the outside. This gas flow F2′ helps to cool the oil in the circuit C2, then enters the device 30 to help cool the oil in the circuit C1.

The device 30 is thus traversed by a gas flow F2′ which has already been used for cooling, which limits the impact on the remaining gas flow which bypasses the system 20. As the temperature of the oil in the circuit C2 is lower than the temperature of the oil in circuit C1, the cooling requirement of the circuit C2 is lower than the cooling requirement of the circuit C1. This means that the power dissipated by the circuit C2 in the gas flow is relatively low and has little effect on the temperature of this gas flow, which can ensure effective cooling of the oil circuit C1 in the device 30.

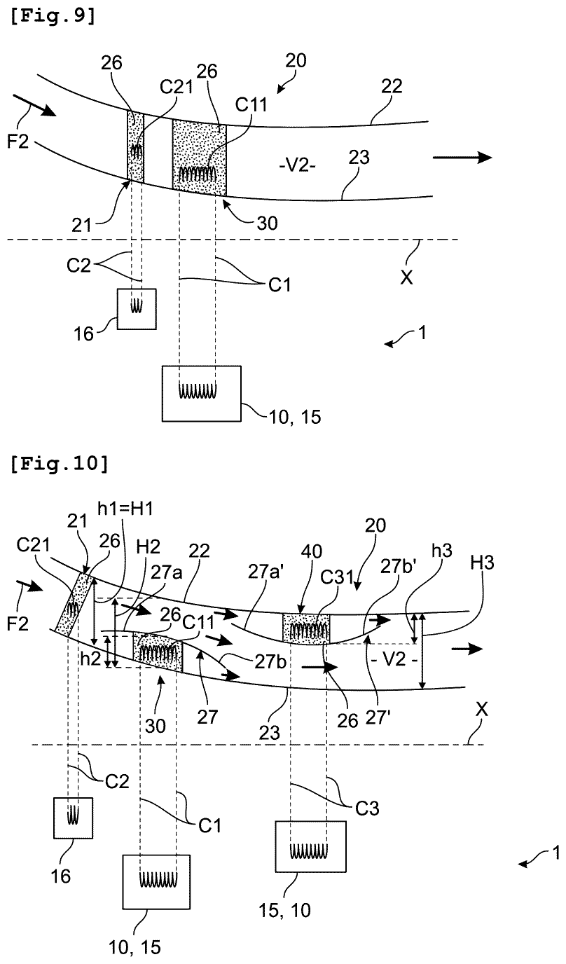

The second embodiment shown in FIG. 9 differs from the first embodiment in that the devices 21, 30 extend over the entire height of the duct V2 and are therefore connected to the two walls 22, 23 respectively.

The devices 21, 30 are axially spaced apart from each other and do not comprise a cowl.

Each of the devices 21, 30 may comprise a single heat exchange matrix 26, or may be sectorized and comprise two or more heat exchange matrices distributed around the axis X, as mentioned above.

It is understood that all of the gas flow F2 flowing in the duct V2 will enter the device 21 and will help to cool the oil in the circuit C2, then will enter the device 30 to help to cool the oil in the circuit C1.

The device 30 is thus traversed by a gas flow F2 that has already been used for cooling, as mentioned above.

The third embodiment shown in FIG. 10 differs from the first embodiment in that it comprises three annular heat exchange devices 21, 30, 40 which extend around the axis X and are located in the duct V2.

The first device 21 is connected to the two walls 22, 23 and extends over the entire height of the duct V2. Its height h1 is therefore equal to the height H1 of the duct in this area. This device is similar to the device 21 in FIG. 9.

The second device 30 is carried by one of the walls, in particular the internal wall 23, and extends over a predetermined height h2 in the duct (of height H2 in this area). This device 30 is similar to device 30 in FIG. 8, with the exception that it includes its own cowl 27.

The third device 40 is carried by the other of the walls, in particular the external wall 22, and extends over a predetermined height h3 in the duct (of height H3 in this area). This device 40 comprises a third cooling circuit C31 which is dedicated to cooling a tertiary oil circuit C3 of another piece of mechanical equipment-advantageously different from the mechanical equipment cooled by the primary circuit C1.

The device 30 is used, for example, to cool the reduction gear 10, and the device 40 is selected, for example, to cool one or more of the bearings 15, or vice versa.

Each of the devices 30, 40 comprises a heat exchange matrix 26 and an annular cowl 27, 27′ which is located between the walls 22, 23 of the duct V2 and which covers this heat exchange matrix 26.

The cowl 27 of the device 30 comprises a first end 27a located upstream of the heat exchange matrix 26 with respect to the flow of the gas flow, and which has a divergent shape with respect to this gas flow F2, and a second end 27b located downstream of the heat exchange matrix 26 with respect to the flow of the gas flow, and which has a convergent shape with respect to this gas flow F2.

The device 40 comprises a cowl 27′ which comprises a first end 27a′ located upstream of the heat exchange matrix 26 with respect to the flow of the gas flow, and which has a divergent shape with respect to this gas flow F2, and a second end 27b′ located downstream of the heat exchange matrix 26 with respect to the flow of the gas flow, and which has a convergent shape with respect to this gas flow F2.

The cowls 27, 27′ of the devices 30, 40 are axially spaced apart, but may alternatively overlap in a radial direction.

It is understood that all of the gas flow F2 flowing in the duct V2 will enter the device 21 and will help to cool the oil in the circuit C2.

Then, an internal peripheral part of the air flow F2 (for example 5 to 30% of the flow rate) flowing in the duct will enter the device 30 while the rest will bypass the device 30. The gas flow entering the device 30 will help to cool the oil in the circuit C1.

A part of the gas flow that bypasses device 30 then enters device 40 to help cool the oil in circuit 3.

In the various embodiments described above, the secondary oil circuit C2 comprises an oil with a temperature of less than or equal to 90° C., for example. The main oil circuit C1, or even the tertiary oil circuit C3 in the case of FIG. 10, comprises an oil with a temperature of less than or equal to 160° C., for example.

The invention offers a number of advantages, including:
Improvement of the aerothermal performance of the devices: the proposed concept allows the flow to be optimized from an aerothermal point of view in each device. In fact, the heat exchange system does not necessarily occupy the entire available radial height, which means that a divergent/convergent device upstream/downstream to better manage the flow in each of the exchangers without obstructing the duct, thereby significantly slowing down the flow through each device. This allows the aerothermal performance of each device to be optimized, reducing air side pressure drops and resulting in more efficient devices.
Installing the devices on both sides of the walls of the duct allows bleed air in at the same temperature at the inlet of these both devices, which is approximately the same as the inlet temperature of the duct. This avoids reusing the same heated air flow from the first exchanger to cool the oil in the second exchanger, thereby increasing the aerothermal performance of both devices.
The axial offset between two devices allows the duct to be unclogged in the radial direction.

1. An aircraft turbine engine, the turbine engine having a longitudinal axis and comprising:
a gas generator extending along the axis and comprising at least one compressor, an annular combustion chamber, and at least one turbine,
a main oil circuit for cooling mechanical equipment of the turbine engine or the gas generator,
a secondary oil circuit for cooling electronic equipment of the turbine engine or gas generator,
a flow duct for a gas flow which flows in the turbine engine and/or the gas generator, this duct being defined by two annular walls, external and internal respectively, which extend around each other and around the axis, and
a heat exchange system located in said duct to be swept by at least part of said gas flow this heat exchange system comprising a first cooling circuit connected to the secondary oil circuit and a second cooling circuit connected to the main oil circuit,
wherein the heat exchange system comprises first and second annular heat exchange devices, which are independent and arranged axially one behind the other in the duct. the first heat exchange device comprising said first cooling circuit which is dedicated to cooling the secondary oil circuit, and the second heat exchange device comprising said second cooling circuit which is dedicated to cooling the main oil circuit, the first heat exchange device being located upstream of the second heat exchange device with respect to the direction of flow of the gas flow in the duct.

2. The turbine engine according to claim 1, wherein the devices are carried by one of the walls and extend over only part of a height of the duct, this height being measured in a radial direction in an area of the duct in which the devices are located.

3. The turbine engine according to claim 2, wherein the devices extend over at most 75% of the height of the duct.

4. The turbine engine according to claim 2, wherein the devices each comprise a heat exchange matrix and a single annular cowl which is located between the walls of the duct and which covers the heat exchange matrices of the two devices, the cowl comprising a first end which is located upstream of the heat exchange matrix of the first device and which has a divergent shape with respect to the gas flow, and a second end which is located downstream of the heat exchange matrix of the second device and which has a shape that converges with respect to the gas flow.

5. The turbine engine according to claim 1, wherein the devices are connected to the two walls and extend over an entire height of the duct, this height being measured in a radial direction in an area of the duct in which the devices are located.

6. The turbine engine according to claim 1, wherein the heat exchange system comprises a third annular heat exchange device which is independent of the first and second heat exchange devices and which is arranged downstream of the first and second heat exchange devices, the third heat exchange device comprising a third cooling circuit.

7. The turbine engine according to claim 6, wherein the third device is carried by one of the walls and extends over only part of a height of the duct, this height being measured in a radial direction in an area of the duct in which the third device is located.

8. The turbine engine according to claim 7, wherein:
the first device is connected to the two walls and extends over an entire height of the duct, this height being measured in a radial direction in an area of the duct in which the first device is located,
the second device is carried by one of the walls and extends over only part of a height of the duct, this height being measured in a radial direction in an area of the duct in which the second device is located, and
the third device is carried by the other of the walls and extends over only part of a height of the duct, this height being measured in a radial direction in an area of the duct in which the third device is located.

9. The turbine engine according to claim 8, wherein each of the second and third devices comprises a heat exchange matrix and an annular cowl which is located between the walls of the duct and which covers this heat exchange matrix, the cowl comprising a first end which is located upstream of the heat exchange matrix and which has a divergent shape with respect to the gas flow, and a second end which is located downstream of the heat exchange matrix and which has a convergent shape with respect to this gas flow.

10. The turbine engine according to claim 9, wherein the cowls of the second and third devices are at an axial distance from each other, or overlap each other in the radial direction.

11. The turbine engine according to claim 1, wherein the mechanical equipment is a rolling bearing or a reduction gear, and the electronic equipment is a computer or an electrical machine.

12. The turbine engine according to claim 11, wherein the heat exchange system comprises a third annular heat exchange device, which is independent of the first and second heat exchange devices and which is arranged downstream of the first and second heat exchange devices, the third heat exchange device comprising a third cooling circuit. and. wherein the third cooling circuit is connected to a tertiary oil circuit which is dedicated to cooling other mechanical equipment.

13. The turbine engine according to claim 1, wherein the devices are at an axial distance from each other, or from one another.

14. The turbine engine according to one claim 1, wherein the first heat exchange device is of the surface type, and/or the second heat exchange device is of the surface type, and/or the third heat exchange device is of the surface type.

15. The turbine engine according to claim 1, wherein said or each heat exchange device is of the SACOC or ACOC type.

16. A method of cooling at least one piece of mechanical equipment and one piece of electronic equipment in a turbine engine according to claim 1, in which the secondary oil circuit comprises an oil having a temperature less than or equal to 90° C., and the main oil circuit, or even the tertiary oil circuit, comprises an oil having a temperature less than or equal to 160° C.

17. The turbine engine according to claim 2, wherein the devices extend over at most 50%, of the height of the duct.
